(19) United States
(12) Patent Application Publication
(10) Pub. No.: US 2018/0114198 A1
(43) Pub. Date: Apr. 26, 2018

(54) PROVIDING USERS WITH REMINDERS HAVING VARYING PRIORITIES

(71) Applicant: Microsoft Technology Licensing, LLC, Redmond, WA (US)

(72) Inventors: Nikrouz Ghotbi, Redmond, WA (US); Nicole Barbara Lee, San Francisco, CA (US)

(21) Appl. No.: 15/332,441

(22) Filed: Oct. 24, 2016

(51) Int. Cl. G06Q 10/10

(52) U.S. Cl. CPC G06Q 10/1097

(57) ABSTRACT

Reminders are provided to a user. A particular reminder for the user and a confidence level associated with the particular reminder are input. A current priority level for the particular reminder is then computed, where this computation is based on reminder prioritization factors that include this confidence level, a current context for the user, and additional information about this current context. One or more user notification methods for providing the particular reminder to the user are then selected, where this selection is based on notification method selection factors that include the computed current priority level for the particular reminder, the current context for the user, and the additional information about this current context. The selected user notification methods are then utilized to provide the particular reminder to the user.

### BACKGROUND

The Internet is a global data communications system that serves billions of people across the globe and provides them access to a vast array of online information resources and services including those provided by the World Wide Web and intranet-based enterprises. Thanks to the ubiquity of the Internet and the wide variety of network-enabled end-user computing devices that exist today, many of which are mobile computing devices, people today spend a large and ever-increasing amount of time online (e.g., using various types of end-user computing devices that are configured to operate over a data communication network such as the Internet, among other types of networks). For example, many people today schedule the various upcoming events in their life (e.g., their professional and personal meetings and appointments) and manage their calendars that keep track of these events using an electronic (e.g., computer-based and thus software-based) calendar application (also known as an online calendar). Many people today also create and maintain electronic to-do lists of tasks and actions to be completed. Many people today also heavily rely on electronic messages to communicate with each other in both a professional and a personal context. As such, for many people today their end-user computing devices have become an indispensable tool for managing the many different facets of their professional and personal lives.

### SUMMARY

Reminder provisioning technique implementations described herein generally provide reminders to a user. In an exemplary implementation a particular reminder for the user and a confidence level associated with the particular reminder are input. A current priority level for the particular reminder is then computed, where this computation is based on reminder prioritization factors that include this confidence level, a current context for the user, and additional information about this current context. One or more user notification methods for providing the particular reminder to the user are then selected, where this selection is based on notification method selection factors that include the computed current priority level for the particular reminder, the current context for the user, and the additional information about this current context. The selected user notification methods are then utilized to provide the particular reminder to the user.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more-detailed description that is presented below.

### DESCRIPTION OF THE DRAWINGS

The specific features, aspects, and advantages of the reminder provisioning technique implementations described herein will become better understood with regard to the following description, appended claims, and accompanying drawings where:

FIG. 1 is a diagram illustrating one implementation, in simplified form, of a system framework for realizing the reminder provisioning technique implementations described herein.

FIG. 2 is a diagram illustrating another implementation, in simplified form, of a system framework for realizing the reminder provisioning technique implementations described herein.

FIG. 3 is a flow diagram illustrating an exemplary implementation, in simplified form, of a process for providing reminders to a user.

FIG. 4 is a diagram illustrating an exemplary implementation, in simplified form, of a reminder provisioner computer program.

FIG. 5 is a diagram illustrating a simplified example of a general-purpose computer system on which various implementations and elements of the reminder provisioning technique, as described herein, may be realized.

### DETAILED DESCRIPTION

In the following description of reminder provisioning technique implementations reference is made to the accompanying drawings which form a part hereof, and in which are shown, by way of illustration, specific implementations in which the reminder provisioning technique can be practiced. It is understood that other implementations can be utilized and structural changes can be made without departing from the scope of the reminder provisioning technique implementations.

It is also noted that for the sake of clarity specific terminology will be resorted to in describing the reminder provisioning technique implementations described herein and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation”, or “one version”, or “another version”, or an “exemplary version”, or an “alternate version”, or “one variant”, or “another variant”, or an “exemplary variant”, or an “alternate variant” means that a particular feature, a particular structure, or particular characteristics described in connection with the implementation/version/variant can be included in at least one implementation of the reminder provisioning technique. The appearances of the phrases “in one implementation”, “in another implementation”, “in an exemplary implementation”, “in an alternate implementation”, “in one version”, “in another version”, “in an exemplary version”, “in an alternate version”, “in one variant”, “in another variant”, “in an exemplary variant”, and “in an alternate variant” in various places in the specification are not necessarily all referring to the same implementation/version/variant, nor are separate or alternative implementations/versions/variants mutually exclusive of other implementations/versions/variants. Yet furthermore, the order of process flow representing one or more implementations, or versions, or variants of the reminder provisioning technique does not inherently indicate any particular order nor imply any limitations of the reminder provisioning technique.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” variants thereof, and other similar words are used in either this detailed description or the claims, these terms are intended to be inclusive, in a manner similar to the term “comprising”, as an open transition word without precluding any additional or other elements.

1.0 Providing Users with Reminders Having Varying Priorities

The reminder provisioning technique implementations described herein generally automatically provide reminders to a user via a variety of user notification methods (e.g., user experience affordances), where the reminders can have varying priorities (e.g., varying degrees of urgency/importance) and each reminder is provided to the user using one or more of these notification methods that are selected based on a variety of notification method selection factors that include a current priority level (e.g., score) that is computed for the reminder, a current context for the user (e.g., where the user is currently located and/or what the user is currently doing, among other types of contexts for the user), and additional information (e.g., intelligence) about this current context. In other words and as will be appreciated from the more-detailed description that follows, rather than treating all reminders for the user as being equally important (e.g., having the same sense of priority) the reminder provisioning technique implementations generally operate to understand each individual reminder and its current relative urgency (e.g., importance to the user) and then provide the reminder to the user in one or more ways (e.g., using one or more user notification methods) that appropriately reflect its current relative urgency and take the user's current context into consideration. The reminder provisioning technique implementations thus generally provide the user with multi-modal reminders that leverage a variety of user notification methods to differentiate the reminders based on their current relative priorities and communicate each reminder to the user in an appropriate manner (e.g., using one or more appropriate user notification methods) that takes these priorities and the user's current context into consideration. The term “user” is used herein to refer to a person who is using the reminder provisioning technique implementations.

The reminder provisioning technique implementations described herein are advantageous for various reasons including, but not limited to, the following. As will be appreciated from the foregoing and the more-detailed description that follows, the reminder provisioning technique implementations increase user efficiency and productivity since reminders are automatically provided to the user in a manner that appropriately reflects the current relative urgency of each reminder and takes into consideration the user's current context. As such the reminder provisioning technique implementations provide reminders to the user at the right time and place without inappropriately distracting (e.g., disturbing, annoying, or the like) the user. The reminder provisioning technique implementations also eliminate the need for the user to have to manually evaluate their calendar (or calendars in the case where the user has a plurality of different calendars), and manually evaluate their to-do list (or to-do lists in the case where the user has a plurality of different to-do lists), and manually evaluate their electronic messages in order to keep track of the aforementioned various upcoming events that are scheduled in their life, and their tasks and actions that are to be completed either by them or for them. The reminder provisioning technique implementations also eliminate the user being caught off guard by unexpected events, and prevent things from “slipping through the cracks.”

Additionally, the reminder provisioning technique implementations described herein are operable with any type of end-user computing device, examples of which are described in more detail hereafter. The reminder provisioning technique implementations may also be employed by a wide variety of computing (e.g., software-based) applications that can be run (e.g., executed) on a given end-user computing device that is utilized by the user—for convenience sake such computing applications are hereafter simply referred to as applications. For example, the reminder provisioning technique can be employed by any type of intelligent personal assistant application (e.g., CORTANA® (a registered trademark of Microsoft Corporation) intelligent personal assistant application or SIRI® (a registered trademark of Apple Inc.) intelligent personal assistant application), any type of electronic personal information management application, any type of electronic calendar application, any type of electronic task tracking and management application, any type of personal productivity application, any type of chat application, any type of electronic messaging application, any type of video conferencing application, and any other type of application that may provide its users with reminders.

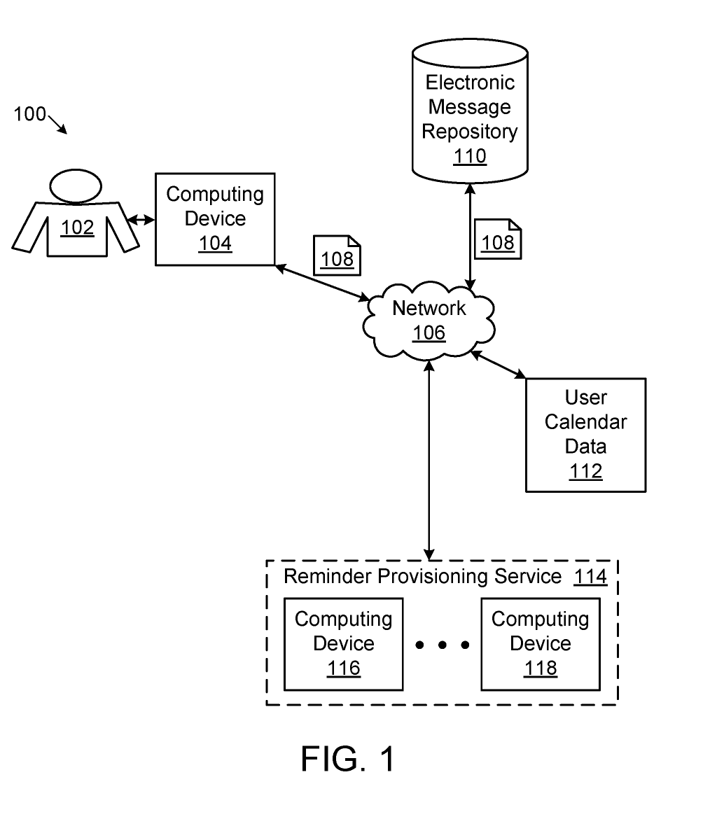

FIG. 1 illustrates one implementation, in simplified form, of a system framework for realizing the reminder provisioning technique implementations described herein. As exemplified in FIG. 1, the system framework 100 includes an end-user computing device 104 that is configured to communicate various types of information over a conventional data communication network 106 (herein also referred to as a computer network) such as the Internet (among other types of conventional data communication networks)—examples of such information are described in more detail hereafter. The computing device 104 can be any type of conventional mobile computing device such as a smartphone, or a tablet computer, or a laptop computer (sometimes also referred to as a notebook or netbook computer), or a computing device that is integrated into an automobile (e.g., a car, or a truck, or any other type of motorized vehicle), among other types of conventional mobile computing devices. The computing device 104 can also be any type of conventional non-mobile computing device such as a desktop personal computer (PC), or a video game console, among other types of conventional non-mobile computing devices.

Referring again to FIG. 1, the end-user computing device 104 is utilized by a user 102 to perform a wide variety of tasks. For example, the user 102 may schedule the various upcoming events in their life (e.g., their professional and personal meetings and appointments) and may manage their calendar(s) that keeps track of these events using a conventional electronic calendar application (not shown, hereafter simply referred to as a calendar application) that runs on the computing device 104, where this calendar application may include a conventional personal information management application that supports electronic calendars. As is appreciated in the art of electronic calendaring, various conventional calendar applications exist today which vie for popularity. While some of today's calendar applications may store the user's 102 calendar data locally on the computing device 104, many of today's calendar applications are web-based (e.g., they store the user's calendar data 112 in the cloud). Today's calendar applications may also provide a variety of other features such as allowing the user's calendar data 112 to be synchronized across each of the other end-user computing devices (not shown) that the user 102 may utilize. Today's calendar applications may also allow the user's calendar data 112 to be shared with other people (not shown), and to be synchronized with these other people's calendars. Many of today's calendar applications support a conventional open protocol that can be used to access the user's calendar data 112 via the data communication network 106.

As described heretofore, many people today heavily rely on electronic messages to communicate with each other in both a professional and a personal context. In the course of this communication via electronic messages one or more tasks are often discussed between a plurality of people and the responsibility for completing a given task is often assigned to one or more of the people who are involved in this discussion. For example, the user may receive an electronic message from another person, where in this message the other person makes a request of the user (e.g., the other person may ask the user to perform a specific task). The user may also send an electronic message to another person, where in this message the user makes a request of the other person (e.g., the user may ask the other person to perform a specific task). The user may also send an electronic message to another person, where in this message the user offers to complete a specific task for the other person. The user may also receive an electronic message from another person, where in this message the other person offers to complete a specific task for the user. As is appreciated in the art of electronic messaging over data communication networks, people today routinely exchange various types of electronic messages with each other including, but not limited to, email (also known as electronic mail and e-mail) messages, instant text messages (also known as SMS (Short Message Service) messages), instant multimedia messages (also known as MMS (Multimedia Messaging Service) messages), online chat messages (also known as instant messaging (IM), among other things), recorded voice messages (e.g., recorded phone calls and the like), recorded video messages (e.g., recorded video calls and the like), blog postings on the World Wide Web (herein sometimes simply referred to as the web), user postings on social networking websites, and fax (also known as facsimile or telefax) messages.

Referring again to FIG. 1, the user 102 may also utilize the end-user computing device 104 to send electronic messages 108 to, and receive electronic messages 108 from, other people over the data communication network 106. These messages 108 that are sent and received by the user 102 may be stored locally on the computing device 104, and may also be stored in an electronic message repository 110 that resides in the cloud. The reminder provisioning technique implementations described herein support the communication of any type of electronic message 108 between the user 102 and other people. By way of example but not limitation, in one implementation of the reminder provisioning technique described herein the electronic messages 108 that are sent and received by the user 102 include one or more email messages which may include one or more email threads. As is appreciated in the art of email messaging, an email thread is an email message that includes a chronologically-ordered concatenation of an original email message and each of the succeeding replies thereto. Accordingly, an email thread provides a chronologically-ordered record of an email-based conversation that takes place between a plurality of people. In another implementation the electronic messages 108 may include one or more instant text messages, or one or more instant multimedia messages, or one or more online chat messages. In another implementation the messages 108 may include one or more recorded voice messages that have been converted to text using a conventional speech-to-text (also known as voice-to-text) conversion method, or one or more recorded video messages having audio that has been converted to text using the speech-to-text conversion method. In another implementation the messages 108 may include one or more web-based (e.g., online) blog postings, or one or more user postings on one or more social networking websites. In another implementation the messages 108 may include one or more fax messages that have been converted to text using a conventional optical character recognition method. In another implementation the messages 108 may include any combination of the just-described different types of electronic messages.

Referring again to FIG. 1, the end-user computing device 104, the electronic message repository 110, and the user's calendar data 112 are also configured to communicate over the data communication network 106 with a reminder provisioning service 114 that runs on one or more other computing devices 116/118. These other computing devices 116/118 can also communicate with each other via the network 106. In an exemplary implementation of the reminder provisioning technique described herein the other computing devices 116/118 are located in the cloud so that the reminder provisioning service 114 operates as a cloud service and the network 106 includes wide area network functionality. The term “cloud service” is used herein to refer to a web application that operates in the cloud and can be hosted on (e.g., deployed at) a plurality of data centers that can be located in different geographic regions (e.g., different regions of the world). As will be described in more detail hereafter, the reminder provisioning service 114 generally performs a variety of functions associated with providing reminders to the user 102 via a variety of user notification methods, where the reminders can have varying priorities and each reminder is provided to the user 102 using one or more of these notification methods that are selected based on a variety of notification method selection factors that include a current priority level that is computed for the reminder, a current context for the user 102, and additional information about this current context.

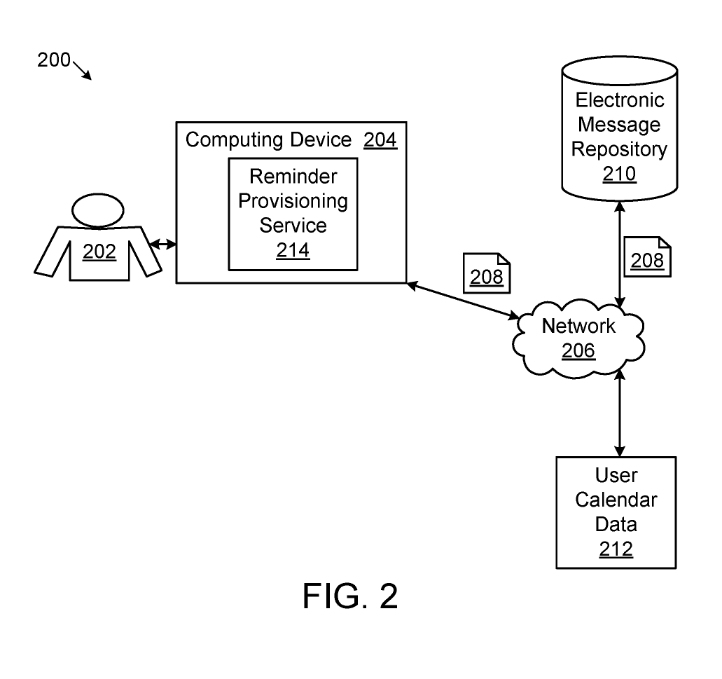

FIG. 2 illustrates another implementation, in simplified form, of a system framework for realizing the reminder provisioning technique implementations described herein. As exemplified in FIG. 2, the system framework 200 includes the aforementioned end-user computing device 204 that is utilized by a user 202 to perform the aforementioned wide variety of tasks. For example, the user 202 may schedule the various upcoming events in their life and manage their calendar(s) that keeps track of these events using the aforementioned calendar application (not shown) that runs on the computing device 204, where this calendar application may store the user's 202 calendar data locally on the computing device 204, and may also store the user's calendar data 212 in the cloud. The user may also utilize the computing device 204 to send electronic messages 208 to, and receive electronic messages 208 from, other people over the aforementioned data communication network 206. These messages 208 that are sent and received by the user 202 may be stored locally on the computing device 204, and may also be stored in the aforementioned electronic message repository 210 that resides in the cloud. The system framework 200 also includes a reminder provisioning service 214 that runs on the computing device 204. As will be described in more detail hereafter, the reminder provisioning service 214 generally performs a variety of functions associated with providing reminders to the user 202 via a variety of user notification methods, where the reminders can have varying priorities and each reminder is provided to the user 202 using one or more of these notification methods that are selected based on the aforementioned variety of notification method selection factors.

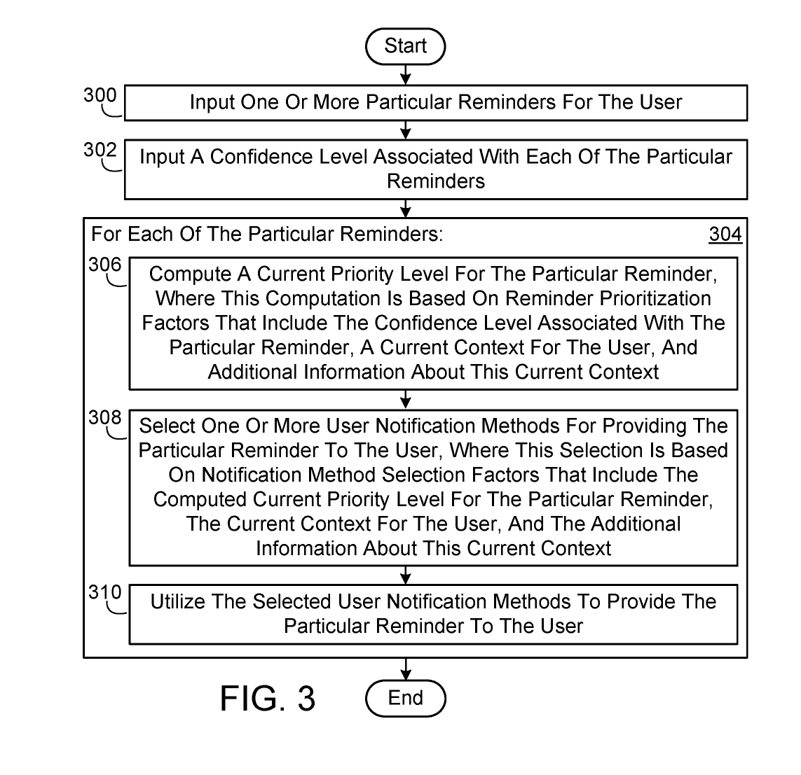

FIG. 3 illustrates an exemplary implementation, in simplified form, of a process for providing reminders to a user. In one implementation of the reminder provisioning technique described herein the process illustrated in FIG. 3 is realized on the system framework 100 illustrated in FIG. 1. In another implementation of the reminder provisioning technique the process illustrated in FIG. 3 is realized on the system framework 200 illustrated in FIG. 2. As exemplified in FIG. 3 the process starts with inputting one or more particular reminders for the user (process action 300), and inputting a confidence level associated with each of the particular reminders (process action 302). It is noted that the reminder provisioning technique implementations described herein can provide any type of reminder to the user, and can identify what the user needs to be reminded about at a given point in time using a variety of conventional methods. By way of example but not limitation, in one implementation of the reminder provisioning technique described herein the particular reminders that are input in action 300 include a pending (e.g., not yet completed) task that the user is assigned to complete (e.g., is responsible for completing). In another implementation of the reminder provisioning technique the particular reminders that are input in action 300 include a pending task that one or more other people are assigned to complete for the user. It will be appreciated that the just-described pending tasks can be identified using a variety of conventional methods. For example, in a tested implementation of the reminder provisioning technique described herein these pending tasks were identified using a conventional task assignment identification method. In another implementation of the reminder provisioning technique the particular reminders that are input in action 300 include an upcoming event that the user is scheduled to attend. It will be appreciated that this upcoming event can be identified using a variety of conventional methods. For example, in an exemplary implementation of the reminder provisioning technique the upcoming event is identified by analyzing the user's aforementioned calendar data.

Referring again to FIG. 3, the particular reminders that are input in action 300 can be generally classified into two categories based on how they were created, namely particular reminders that were explicitly set (e.g., input) by the user, and particular reminders that were implicitly identified by the reminder provisioning technique implementations. One example of a particular reminder that was explicitly set by the user is the case where the user created a reminder that explicitly says “buy milk.” Examples of particular reminders that were implicitly identified by the reminder provisioning technique implementations include the just-described different types of pending tasks and the just-described upcoming event. In the tested implementation of the reminder provisioning technique described herein the confidence level associated with each of the particular reminders that is input in action 300 is based on how the particular reminder was created, and is determined using conventional task and event analysis methods. As such, the reminders that are input in action 300 can have a range of different confidence levels. By way of example but not limitation, in the case where the particular reminder was explicitly set by the user the confidence level associated with this reminder will be high. In the case where the particular reminder was implicitly identified by the reminder provisioning technique implementations the confidence level associated with this reminder will be low.

Referring again to FIG. 3, after the particular reminders for the user and the confidence level associated with each of these particular reminders have been input (actions 300 and 302), the following actions are performed for each of the particular reminders (process action 304). A current priority level is computed for the particular reminder, where this computation is based on a variety of reminder prioritization factors that include the confidence level associated with the particular reminder, a current context for the user, and additional information (e.g., intelligence) about this current context (process action 306). In certain circumstances, the reminder prioritization factors may also include the information content in the particular reminder; one example of such circumstances is the case where the particular reminder involves a pending task and a deadline (e.g., a specific date, or a specific date and time, or the like) that is associated therewith.

Generally speaking and referring again to FIGS. 1 and 2, the current context for the user 102/202 is derived from the end-user computing device 104/204 that is currently being utilized by the user, and includes one or more attributes of the user's current environment, where this context and its attributes may be derived using a variety of conventional methods. More particularly, and by way of example but not limitation, in one implementation of the of the reminder provisioning technique described herein the current context for the user may include the user's current physical location (e.g., whether the user is currently at home, or in their office at work, or traveling in an automobile, among various other physical locations). In one version of the just-described implementation the additional information about the user's current physical location may include data that specifies the geolocation (e.g., the real-world geographic location) of the user's current physical location—examples of such geolocation data that may be employed by the reminder provisioning technique are described in more detail hereafter. In another version of the just-described implementation the additional information about the user's current physical location may include data that specifies an auxiliary user communication device (not shown) that is operable and in the vicinity of the user's current physical location of the user. For example, in the case where the user is either currently at home or in their office at work, the room they are currently in may include a conventional smart speaker device (such as the AMAZON ECHO® (a registered trademark of Amazon Technologies, Inc.) device, or the GOOGLE HOME® (a registered trademark of Google Inc.) device) that may be used to provide an audible notification of a given particular reminder to the user. In the case where the user is currently traveling in an automobile it may include a conventional built-in vehicle infotainment system (also known as an in-car entertainment (ICE) system, or in-vehicle infotainment (IVI) system) that may be used to provide either an audible notification of a given particular reminder to the user, or a visual notification of the particular reminder to the user, or both these audible and visual notifications.

Referring again to FIGS. 1 and 2, in another implementation of the reminder provisioning technique described herein the current context for the user 102/202 may include the type of end-user computing device 104/204 that is currently being utilized by the user. In one version of the just-described implementation the additional information about the type of end-user computing device that is currently being utilized by the user may include data that specifies which applications are installed on this computing device. In another version of the just-described implementation the additional information about the type of end-user computing device that is currently being utilized by the user may include data that specifies which applications the user is currently running (e.g., currently has open) on this computing device. In another version of the just-described implementation the additional information about the type of end-user computing device that is currently being utilized by the user may include data that specifies each of the user notification methods that is available on this computing device—examples of such user notification methods are described in more detail hereafter. In yet another implementation of the reminder provisioning technique the current context for the user 102/202 may include the current date or the current time and date.

Regarding the aforementioned data that specifies the geolocation of the user's current physical location, as is appreciated in the art of geolocation systems and methods, various types of conventional geographic coordinate systems exist that may be used to specify a given geolocation. A popular exemplary geographic coordinate system uses conventional latitude and longitude metrics to specify a given two-dimensional (2D) geolocation, and may also add a conventional altitude (e.g., elevation) metric to specify a given three-dimensional (3D) geolocation. Another exemplary geographic coordinate system uses a set of conventional rectilinear Cartesian (e.g., (x,y) or (x,y,z)) coordinates to specify a given 2D or 3D geolocation. Yet another exemplary geographic coordinate system uses a set of conventional local East, North, Up (ENU) Cartesian coordinates to specify a given 3D geolocation. Yet another exemplary geographic coordinate system uses a set of conventional local North, East, Down (NED) Cartesian coordinates to specify a given 3D geolocation.

Referring again to FIGS. 1 and 2, it is noted that the reminder provisioning technique implementations described herein can utilize a wide variety of user notification methods for providing a given particular reminder to the user 102/202. The only limitation in the types of user notification methods that may be employed by the reminder provisioning technique implementations is that these methods are currently either available on or available to the end-user computing device 104/204 that is currently being utilized by the user 102/202. Exemplary types of user notification methods that may be employed by the reminder provisioning technique implementations are described in more detail hereafter. The various types of user notification methods that may be utilized to provide the particular reminder to the user can be generally classified based on how much they distract the user. In an exemplary implementation of the reminder provisioning technique described herein the user notification methods that may be utilized to provide the particular reminder to the user are classified into three categories, namely user notification methods that are greatly distracting to the user (thus indicating to the user that the particular reminder has a high degree of urgency/importance), user notification methods that are moderately distracting to the user (thus indicating to the user that the particular reminder has a medium degree of urgency/importance), and user notification methods that are not distracting to the user (thus indicating to the user that the particular reminder has a low degree of urgency/importance).

As just described, the reminder provisioning technique implementations described herein can utilize a wide variety of user notification methods for providing a given particular reminder to the user. By way of example but not limitation, in one implementation of the reminder provisioning technique described herein the user notification methods may include making a phone call to the user that provides them with an audible notification of the particular reminder—this particular notification method is herein considered to be greatly distracting to the user. In the case where the end-user computing device that is currently being utilized by the user (hereafter sometimes simply referred to as the user's computing device for simplicity sake) is able to receive phone calls (e.g., this computing device is a smartphone or the like), the just-described phone call to the user may be made to this computing device. In the case where the user's computing device is unable to receive phone calls (e.g., this computing device is a tablet computer, or a laptop computer, or a non-mobile computing device), the just-described phone call to the user may be made to a telephone number that is associated with the user's current physical location (e.g., if the user is currently at home the phone call may be made to the user's home phone number, and if the user is currently in their office at work the phone call may be made to the user's office phone number). In another implementation the user notification methods may include playing an audio message that includes the particular reminder on an auxiliary user communication device that is currently in the vicinity of the user (e.g., this auxiliary user communication device will speak the particular reminder to the user)—this particular notification method is herein also considered to be greatly distracting to the user. In another implementation the user notification methods may include playing a prescribed sound (e.g., a prescribed tone, or a prescribed sequence of tones, or the like) on the user's computing device—this particular notification method is herein also considered to be greatly distracting to the user. In an exemplary version of this implementation the prescribed sound may be turned off after a prescribed period of time has elapsed. In another implementation the user notification methods may include utilizing an intelligent personal assistant application that is installed on the user's computing device to speak the particular reminder—this particular notification method is herein also considered to be greatly distracting to the user.

In another implementation of the reminder provisioning technique described herein the user notification methods may include sending an instant text message that includes the particular reminder to the user—this particular notification method is herein considered to be moderately distracting to the user. In another implementation the user notification methods may include sending an instant multimedia message that includes the particular reminder to the user—this particular notification method is herein also considered to be moderately distracting to the user. In another implementation the user notification methods may include displaying a message that includes the particular reminder on a display screen of an auxiliary user communication device that is currently in the vicinity of the user—this particular notification method is herein also considered to be moderately distracting to the user. In another implementation the user notification methods may include displaying a pop-up message that includes the particular reminder on a display screen of the user's computing device—this particular notification method is herein also considered to be moderately distracting to the user. As is appreciated in the art of computer operating systems and applications, such a pop-up message is sometimes referred to as a toast or a toast notification. In an exemplary version of this implementation, whenever the computed priority level for the particular reminder is below a prescribed threshold this pop-up message will be removed from the display screen after a prescribed period of time has elapsed, and whenever the computed priority level for the particular reminder is above the prescribed threshold the pop-up message will remain on the display screen until the pop-up message is selected by the user. In another implementation the user notification methods may include displaying a message that includes the particular reminder on a desktop of the user's computing device—this particular notification method is herein also considered to be moderately distracting to the user. This message that is displayed on the user's desktop can be thought of as a “digital sticky note” (e.g., a text-based digital object) that can be manipulated (e.g., deleted, moved, edited, saved, or the like) by the user.

In another implementation of the reminder provisioning technique described herein the user notification methods may include sending an email message that includes the particular reminder to the user—this particular notification method is herein considered to be not distracting to the user. In another implementation the user notification methods may include putting the particular reminder onto a to-do list for the user—this particular notification method is herein also considered to be not distracting to the user. In another implementation the user notification methods may include displaying a message that includes the particular reminder on a lock screen of the user's computing device—this particular notification method is herein also considered to be not distracting to the user. In another implementation the user notification methods may include putting the particular reminder into a notification center (also known as an action center) of the user's computing device—this particular notification method is herein also considered to be not distracting to the user. In another implementation the user notification methods may include attaching a message that includes the particular reminder to a particular application that is associated with the particular reminder and is installed on the user's computing device so that this message will be displayed to the user when they next open (e.g., run) this application—this particular notification method is herein also considered to be not distracting to the user. This message that is attached to a computing application can be thought of as the aforementioned “digital sticky note.” It is noted that the reminder provisioning technique can attach a message that includes the particular reminder to any type of conventional application (e.g., a word processing application, or a spreadsheet application, or a presentation application, or an email application, or a web browser application, among many other types of applications).

Referring again to FIG. 3, after the current priority level for a given one of the particular reminders has been computed (action 306), one or more user notification methods for providing the particular reminder to the user are selected (e.g., determined), where this selection is based on a variety of notification method selection factors that include the computed current priority level for the particular reminder, the current context for the user, and the additional information about this current context (process action 308). In certain circumstances, the notification method selection factors may also include the information content in the particular reminder. The selected user notification methods are then utilized to provide the particular reminder to the user (process action 310). In an exemplary implementation of the reminder provisioning technique described herein, whenever the computed current priority level for the particular reminder is high the selected user notification methods are greatly distracting to the user, whenever the computed current priority level for the particular reminder is medium the selected user notification methods are moderately distracting to the user, and whenever the computed current priority level for the particular reminder is low the selected user notification methods are not distracting to the user.

Given the foregoing, it will be appreciated that the reminder provisioning technique implementations described herein provide timely reminders to the user by utilizing one or more user notification methods that appropriately distract the user (e.g., get their attention) based on an understanding of each reminder and what the user is currently doing (e.g., the activities they are currently involved in). Referring again to FIG. 3, it will also be appreciated that the combination of actions 306, 308 and 310 has the advantageous technical effect of increasing the user's efficiency and productivity since these actions operate to understand each of the particular reminders for the user and its current relative urgency, and then provide each of the particular reminders to the user via user notification methods that take the user's current context into consideration and differentiate the particular reminder based on its current relative urgency. Several exemplary reminder provisioning scenarios, in simplified form, will now be discussed in order to aid in the understanding of the reminder provisioning technique implementations described herein.

Consider the aforementioned exemplary case where the user created a particular reminder that explicitly says “buy milk.” The confidence level associated with this particular reminder will be high since it was explicitly set by the user. In one exemplary situation where the user is currently running a web browser application on their computing device and navigates to a particular website that happens to sell milk, the reminder provisioning technique implementations described herein may display a pop-up message that includes the particular reminder on the computing device's display screen while the user is browsing this particular website. In another exemplary situation where the user's current physical location is either nearby or within a retail store that happens to sell milk, the reminder provisioning technique implementations may utilize an intelligent personal assistant application that is installed on the user's computing device to speak the particular reminder; if the user's computing device is a smartphone the reminder provisioning technique implementations may also make a phone call to this smartphone that provides the user with an audible notification of the particular reminder.

Consider another exemplary case where the user created a particular reminder that explicitly says “buy toy for Jill” who is the user's daughter and whose birthday is the next day. The confidence level associated with this particular reminder will be high since it was explicitly set by the user. In an exemplary situation where the user is currently traveling in an automobile that is equipped with the aforementioned vehicle infotainment system and the automobile approaches a retail store which happens to sell toys, the reminder provisioning technique implementations described herein may play an audio message that includes the particular reminder on the automobile's infotainment system.

Consider yet another exemplary case where a particular reminder for the user was implicitly identified and this reminder involves a pending task that the user is assigned to complete. The confidence level associated with this particular reminder will be low since it was implicitly identified. In one exemplary situation where no deadline is associated with this pending task, the reminder provisioning technique implementations described herein may display a message that includes the particular reminder on a lock screen of the user's computing device, or may put the particular reminder into a notification center of this computing device, or may send an email message that includes the particular reminder to the user, or may put the particular reminder onto a to-do list for the user, or may implement any combination of these user notification methods. In an exemplary variant of the just-described situation where the pending task is to write, or finish writing, a document that is created using a particular word processing application, the reminder provisioning technique implementations may also attach a message that includes the particular reminder to this word processing application so that this message will be displayed to the user when they next open the word processing application. In another exemplary situation where there is a deadline associated with the pending task, the reminder provisioning technique implementations described herein may display a message that includes the particular reminder on a desktop of the user's computing device, or may send an instant text or instant multimedia message that includes the particular reminder to the user, or may display a pop-up message that includes the particular reminder on the computing device's display screen.

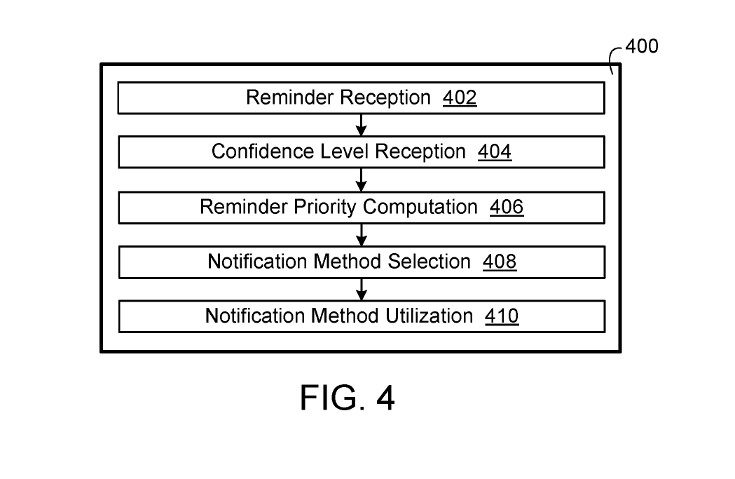

FIG. 4 illustrates an exemplary implementation, in simplified form, of a reminder provisioner computer program. As exemplified in FIG. 4 and referring again to FIG. 3, the reminder provisioner computer program 400 includes, but is not limited to, a reminder reception sub-program 402 that performs action 300, a confidence level reception sub-program 404 that performs action 302, a reminder priority computation sub-program 406 that performs action 306 for each reminder, a notification method selection sub-program 408 that performs action 308 for each reminder, and a notification method utilization sub-program 410 that performs action 310 for each reminder. Each of the just-described sub-programs is realized on a computing device such as that which is described in more detail in the Exemplary Operating Environments section which follows. More particularly and by way of example but not limitation, and referring again to FIGS. 1 and 2, in one implementation of the reminder provisioning technique described herein the just-described sub-programs may be realized on the computing devices 116/118. In another implementation of the reminder provisioning technique the just-described sub-programs may be realized on the end-user computing device 204.

### 2.0 Other Implementations

While the reminder provisioning technique has been described by specific reference to implementations thereof, it is understood that variations and modifications thereof can be made without departing from the true spirit and scope of the reminder provisioning technique. It is noted that any or all of the implementations that are described in the present document and any or all of the implementations that are illustrated in the accompanying drawings may be used and thus claimed in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

### 3.0 Exemplary Operating Environments

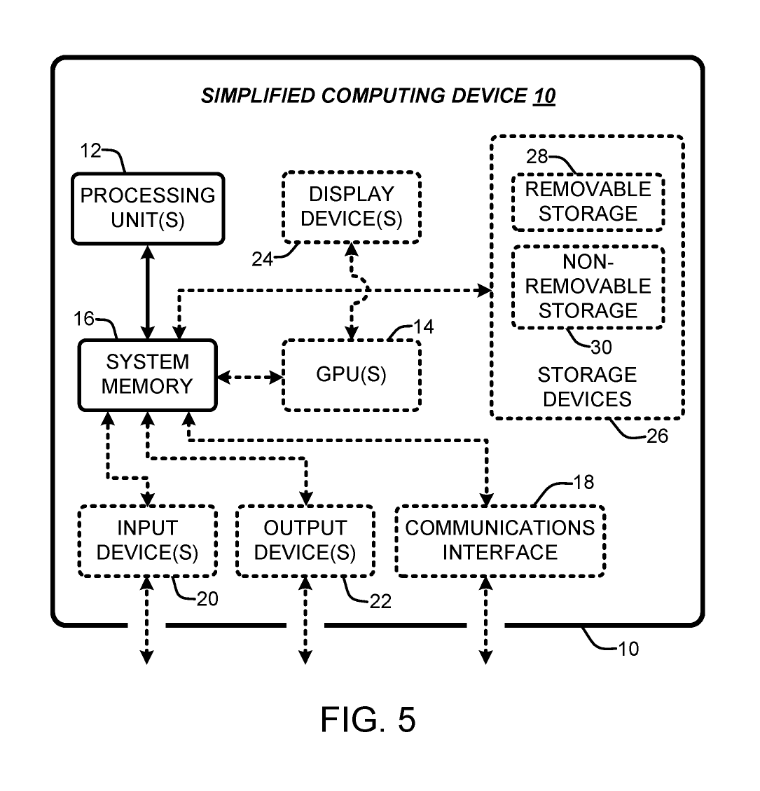

The reminder provisioning technique implementations described herein are operational within numerous types of general purpose or special purpose computing system environments or configurations. FIG. 5 illustrates a simplified example of a general-purpose computer system on which various implementations and elements of the reminder provisioning technique, as described herein, may be implemented. It is noted that any boxes that are represented by broken or dashed lines in the simplified computing device 10 shown in FIG. 5 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the reminder provisioning technique implementations described herein, the device should have a sufficient computational capability and system memory to enable basic computational operations. In particular, the computational capability of the simplified computing device 10 shown in FIG. 5 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 10 and with any other component or feature of the reminder provisioning technique implementations described herein, including input, output, control, feedback, and response to one or more users or other devices or systems associated with the reminder provisioning technique implementations, are enabled by a variety of Natural User Interface (NUI) scenarios. The NUI techniques and scenarios enabled by the reminder provisioning technique implementations include, but are not limited to, interface technologies that allow one or more users user to interact with the reminder provisioning technique implementations in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors (e.g., speech and/or voice recognition). Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the reminder provisioning technique implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the reminder provisioning technique implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 5 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, programs, sub-programs, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, programs, sub-programs, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, sub-programs, and/or computer program products embodying some or all of the various reminder provisioning technique implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The reminder provisioning technique implementations described herein may be further described in the general context of computer-executable instructions, such as programs, sub-programs, being executed by a computing device. Generally, sub-programs include routines, programs, objects, components, data structures, and the like, that perform particular tasks or implement particular abstract data types. The reminder provisioning technique implementations may also be practiced in distributed computing environments where tasks are performed by one or more remote processing devices, or within a cloud of one or more devices, that are linked through one or more communications networks. In a distributed computing environment, sub-programs may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include FPGAs, application-specific integrated circuits (ASICs), application-specific standard products (ASSPs), system-on-a-chip systems (SOCs), complex programmable logic devices (CPLDs), and so on.

Wherefore, what is claimed is:

1. A system for providing reminders to a user, comprising:
a reminder provisioner comprising one or more computing devices, said computing devices being in communication with each other via a computer network whenever there is a plurality of computing devices, and a computer program having a plurality of sub-programs executable by said computing devices, wherein the sub-programs configure said computing devices to,
input a particular reminder for the user,
input a confidence level associated with the particular reminder,
compute a current priority level for the particular reminder, said computation being based on reminder prioritization factors comprising said confidence level, a current context for the user, and additional information about said current context,
select one or more user notification methods for providing the particular reminder to the user, said selection being based on notification method selection factors comprising the computed current priority level for the particular reminder, said current context, and the additional information about said current context, and
utilize the selected user notification methods to provide the particular reminder to the user.

2. The system of claim 1, wherein the particular reminder comprises one of:
a pending task that the user is assigned to complete; or
a pending task that one or more other people are assigned to complete for the user; or
an upcoming event that the user is scheduled to attend.

3. The system of claim 1, wherein said confidence level is based on how the particular reminder was created.

4. The system of claim 1, wherein said current context comprises a current physical location of the user.

5. The system of claim 4, wherein the additional information about said current context comprises one or more of:
data specifying the geolocation of the current physical location of the user; or
data specifying an auxiliary user communication device that is operable and in a vicinity of the current physical location of the user.

6. The system of claim 1, wherein said current context comprises a type of computing device that is currently being utilized by the user.

7. The system of claim 6, wherein the additional information about said current context comprises one or more of:
data specifying which computing applications are installed on said computing device; or
data specifying which computing applications the user is currently running on said computing device; or
data specifying each of the user notification methods that is available on said computing device.

8. The system of claim 1, wherein said current context comprises one of:
a current date; or
a current time and date.

9. The system of claim 1, wherein,
whenever the computed current priority level for the particular reminder is high the selected user notification methods are greatly distracting to the user,
whenever the computed current priority level for the particular reminder is medium the selected user notification methods are moderately distracting to the user, and
whenever the computed current priority level for the particular reminder is low the selected user notification methods are not distracting to the user.

10. The system of claim 1, wherein the user notification methods comprise one or more of:
making a phone call to the user that provides them with an audible notification of the particular reminder; or
playing an audio message comprising the particular reminder on an auxiliary user communication device that is currently in the vicinity of the user; or
playing a prescribed sound on a computing device that is currently being utilized by the user; or
utilizing an intelligent personal assistant application installed on said computing device to speak the particular reminder.

11. The system of claim 1, wherein the user notification methods comprise one or more of:
displaying a message comprising the particular reminder on a display screen of an auxiliary user communication device that is currently in the vicinity of the user; or
displaying said message on a desktop of a computing device that is currently being utilized by the user; or
sending an instant text message comprising the particular reminder to the user; or
sending an instant multimedia message comprising the particular reminder to the user; or
displaying a pop-up message comprising the particular reminder on a display screen of said computing device.

12. The system of claim 1, wherein the user notification methods comprise one or more of:
displaying a message comprising the particular reminder on a lock screen of a computing device that is currently being utilized by the user; or
putting the particular reminder into a notification center of said computing device; or
attaching said message to a particular computing application that is associated with the particular reminder and is installed on said computing device so that said message is displayed to the user when they next open said application; or
sending an email message comprising the particular reminder to the user; or
putting the particular reminder onto a to-do list for the user.

13. A reminder provisioning system, comprising:
a reminder provisioner comprising a computing device that is currently being utilized by a user, and a computer program having a plurality of sub-programs executable by said computing device, wherein the sub-programs configure said computing device to,
input a particular reminder for the user,
input a confidence level associated with the particular reminder,
compute a current priority level for the particular reminder, said computation being based on reminder prioritization factors comprising said confidence level, a current context for the user, and additional information about said current context,
select one or more user notification methods for providing the particular reminder to the user, said selection being based on notification method selection factors comprising the computed current priority level for the particular reminder, said current context, and the additional information about said current context, and
utilize the selected user notification methods to provide the particular reminder to the user.

14. The system of claim 13, wherein the particular reminder comprises one of:
a pending task that the user is assigned to complete; or
a pending task that one or more other people are assigned to complete for the user; or
an upcoming event that the user is scheduled to attend.

15. The system of claim 13, wherein,
said confidence level is high whenever the particular reminder was explicitly set by the user, and
said confidence level is low whenever the particular reminder was implicitly identified.

16. The system of claim 13, wherein,
whenever the computed current priority level for the particular reminder is high the selected user notification methods are greatly distracting to the user,
whenever the computed current priority level for the particular reminder is medium the selected user notification methods are moderately distracting to the user, and
whenever the computed current priority level for the particular reminder is low the selected user notification methods are not distracting to the user.

17. The system of claim 13, wherein the user notification methods comprise one or more of:
making a phone call to the user that provides them with an audible notification of the particular reminder; or
playing an audio message comprising the particular reminder on an auxiliary user communication device that is currently in the vicinity of the user; or
playing a prescribed sound on said computing device; or
utilizing an intelligent personal assistant application installed on said computing device to speak the particular reminder.

18. The system of claim 13, wherein the user notification methods comprise one or more of:
displaying a message comprising the particular reminder on a display screen of an auxiliary user communication device that is currently in the vicinity of the user; or
displaying said message on a desktop of said computing device; or
sending an instant text message comprising the particular reminder to the user; or
sending an instant multimedia message comprising the particular reminder to the user; or
displaying a pop-up message comprising the particular reminder on a display screen of said computing device.

19. The system of claim 13, wherein the user notification methods comprise one or more of:
displaying a message comprising the particular reminder on a lock screen of said computing device; or
putting the particular reminder into a notification center of said computing device; or
attaching said message to a particular computing application that is associated with the particular reminder, and that the user runs on said computing device; or
sending an email message comprising the particular reminder to the user; or
putting the particular reminder onto a to-do list for the user.

20. A computer-implemented process for providing reminders to a user, the process comprising the actions of:
using one or more computing devices to perform the following process actions, the computing devices being in communication with each other via a computer network whenever a plurality of computing devices is used:
inputting a particular reminder for the user;
inputting a confidence level associated with the particular reminder;
computing a current priority level for the particular reminder, said computation being based on reminder prioritization factors comprising said confidence level, a current context for the user, and additional information about said current context;
selecting one or more user notification methods for providing the particular reminder to the user, said selection being based on notification method selection factors comprising the computed current priority level for the particular reminder, said current context, and the additional information about said current context; and
utilizing the selected user notification methods to provide the particular reminder to the user.
